(19) United States
(12) Patent Application Publication
(10) Pub. No.: US 2026/0318713 A1
(43) Pub. Date: Oct. 15, 2026

(54) POSITION DETECTION SYSTEM AND ACTUATOR

(71) Applicant: FANUC CORPORATION, Yamanashi (JP)

(72) Inventor: Taichi Taguchi, Yamanashi (JP)

(21) Appl. No.: 19/484,215

(22) PCT Filed: Jun. 5, 2023
(86) PCT No.: PCT/JP2023/020800

§ 371 Date: Nov. 13, 2025

(51) Int. Cl. G01D 5/16; G01B 7/30

(52) U.S. Cl. CPC G01D 5/16; G01B 7/30

(57) ABSTRACT

This position detection system includes a primary encoder that detects the position of a motor shaft of a motor, and a secondary encoder that detects the position of an output shaft of a reduction gear. A total rotation determination circuit for calculating the total number of rotations of the output shaft includes a rotating disk that is magnetized in a specific magnetization pattern and rotates coaxially with the output shaft, and a magnetoresistive switch disposed facing the rotating disk.

### CROSS-REFERENCE TO RELATED APPLICATIONS

This application is a National Stage application of International Application No. PCT/JP2023/020800 filed Jun. 5, 2023.

### FIELD

The present disclosure relates to a position detection system and an actuator.

### BACKGROUND

Actuators comprise a servo motor and a speed reducer which are connected to each other. A primary encoder is connected to the motor shaft of the servo motor for detecting the absolute position of the motor shaft within one rotation and the total rotation number of the motor shaft. Likewise, a secondary encoder is connected to the output shaft of the speed reducer for detecting the absolute position of the output shaft within one rotation and the total rotation number of the output shaft (refer to, for example, Japanese Unexamined Patent Publication (Kokai) No. 2007-113932). Information detected by each encoder is stored in a memory.

In specific situations, such as when the main power source is cut off and the servo motor stops, causing the output shaft of the speed reducer to rotate due to inertia, as long as the output shaft of the speed reducer rotates within one rotation, the total rotation number of the primary encoder can be obtained based on the absolute position information of the secondary encoder. In this case, each encoder can be used continuously without the use of an additional battery.

The actuator described above may be incorporated into a specific machine, such as a robot, which has a shaft capable of rotating between +360° and +720° (one rotation or more and two or fewer rotations). In the specific situation described above, if the shaft rotates between one rotation and two rotations, the total rotation number of the secondary encoder cannot be calculated.

There is a need for a battery-less type position detection system which can detect the total rotation number of a secondary encoder even when the main power source is cut off.

### SUMMARY

According to a first aspect of the present disclosure, there is provided a position detection system, comprising a primary encoder for detecting an absolute angle of a motor shaft of a motor within one rotation, and a secondary encoder for detecting an absolute angle of an output shaft of a speed reducer joined to the motor within one rotation, wherein the secondary encoder includes a total rotation determination circuit for calculating a total rotation number of the output shaft, and the total rotation determination circuit includes a rotating disk which is magnetized with a specific magnetic pattern and rotates coaxially with the output shaft, and a magnetic resistance switch which faces the rotating disk, applies a magnetic flux equal to or greater than a predetermined value, and switches resistance value with hysteresis characteristics depending on the direction of the magnetic flux.

The objects, features, and advantages of the present disclosure will become more apparent from the following description of embodiments in association with the attached drawings.

### BRIEF DESCRIPTION OF DRAWINGS

FIG. 1 is a schematic side view of a position detection system based on a first embodiment of the present disclosure.

FIG. 2A is a view showing a magnetization pattern in the first embodiment.

FIG. 2B is a perspective view of a TMR element.

FIG. 3 is a view showing the relationship between magnetic field and resistance.

FIG. 4 is a flowchart detailing calculation of a total rotation of a motor shaft.

FIG. 5 is a view showing a magnetization pattern of a second embodiment.

FIG. 6A is a schematic side view of a position detection system based on a third embodiment.

FIG. 6B is an end view showing a rotating disk and stator of a secondary encoder.

FIG. 6C is a view similar to FIG. 6B, in which a rotating disk of a primary encoder is added.

FIG. 7 is a schematic side view of a position detection system based on a fourth embodiment of the present disclosure.

### DESCRIPTION OF EMBODIMENTS

The embodiments of the present disclosure will be described below with reference to the accompanying drawings. In the drawings, corresponding constituent elements have been assigned common reference signs.

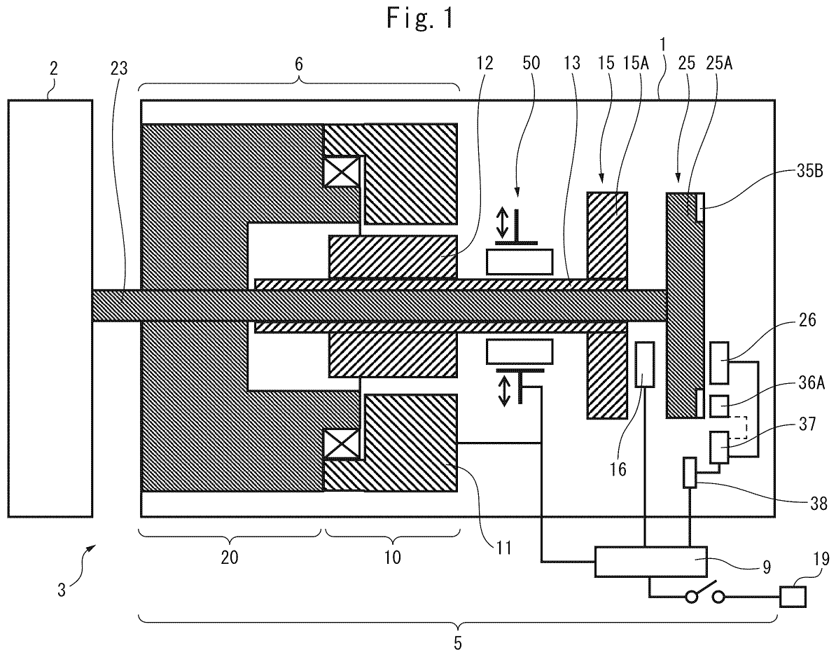

FIG. 1 is a schematic side view of a position detection system based on a first embodiment of the present disclosure. The position detection system 5 is incorporated into a machine 3 having shafts, for example, a robot 3. Though the case in which the position detection system 5 is incorporated into the robot 3 will be described below, the same applies to the case in which the position detection system 5 is incorporated into another machine 3 having shafts, for example, a machine tool.

In FIG. 1, an actuator 6 arranged on a link 1 comprises a motor 10, for example, a servo motor, and a speed reducer 20 which is joined to a motor shaft 13 of the motor 10, connected with each other. The motor 10 comprises a rotor 12 which rotates integrally with the motor shaft 13, and a stator 11 which is arranged so as to surround the rotor 12. The front end of an output shaft 23 of the speed reducer 20 is connected to a link 2. Thus, the actuator 6, which is composed of the motor 10 and the speed reducer 20, positions and controls the link 2 by rotating it relative to the link 1 within a predetermined operating range.

The motor shaft 13 is, for example, a hollow shaft, and a primary encoder 15 is attached to the rear end thereof. The primary encoder 15 is, for example, an incremental encoder for outputting A-phase, B-phase, and Z-phase signals. The output signals are detected by a detection part 16, which detects an absolute position PA1 of the motor shaft 13 within one rotation using a known method. The detection part 16 comprises a circuit for detecting the position PA1. The detection part 16 may also comprise memory, such as volatile memory or non-volatile memory, for storing detected information. Note that the detection part 16 need not necessarily comprise a circuit for detecting a total rotation number PB1 of the motor shaft 13. The total rotation number PB1 of the motor shaft 13 can be calculated as described below.

The output shaft 23 extends toward the motor 10 through the hollow motor shaft 13, and a secondary encoder 25 is attached to the rear end of the output shaft 23. The secondary encoder 25 is, for example, an incremental encoder for outputting A-phase, B-phase, and Z-phase signals. The output signals are detected by a detection part 26, which detects an absolute position PA2 of the output shaft 23 within one rotation using a known method. For this purpose, the detection part 26 comprises a circuit for detecting the absolute position PA2 of the output shaft 23 within one rotation. The detected information can be stored in memory within the circuit, for example, volatile memory or non-volatile memory.

A total rotation determination circuit 37 connected to a magnetic resistance switch, for example, a tunnel magnetoresistance (TMR) element 36A, which is non-rotatably arranged, detects the total rotation number PB2 of the output shaft 23, and in particular, the total rotation number PB2 of the output shaft 23 after it has been disconnected from a main power source 19. Likewise, the detected information can be stored in memory of the total rotation determination circuit 37, for example, volatile memory or nonvolatile memory. The total rotation determination circuit 37 is connected to a controller 9 via a calculation part 38 for calculating the total rotation number PB1 of the motor shaft 13. As is well known, the primary encoder 15 and the secondary encoder 25 each comprise a rotating disk 15A, 25A. The magnetic resistance switch, for example, the TMR element, applies a magnetic flux which is equal to or greater than a predetermined value and switches the resistance value with hysteresis characteristics depending on the direction of the magnetic flux.

Information such as the absolute position PA1, the absolute position PA2, and the total rotation number PB2 described above is supplied to the controller 9 for controlling the robot 3. The controller 9 may be an LSI mounted on the encoders 15, 25, or the controller 9 may comprise memory such as volatile memory or non-volatile memory.

The controller 9, which comprises a CPU, synthesizes positions using a known method based on the supplied information and drives and controls the motor 10. As a result, a positioning operation for positioning the link 2 at a target position relative to the link 1 is performed. Furthermore, a built-in brake 50 provided on the outer surface side of the motor shaft 13 is activated in response to an instruction from the controller 9 to brake the motor shaft 13. The controller 9 also serves to supply/cut off electricity to the primary encoder 15 and the secondary encoder 25 via the external main power source 19 when the robot 3 comprising the links 1, 2 is operating.

As shown in FIG. 1, a specific magnetic pattern 35B is magnetized on the rotating disk 25A of the secondary encoder 25. The magnetic pattern 35B is provided so as to face the TMR element 36A. As will be described later, the magnetic pattern 35B may be provided on a rotating disk 35A different than the rotating disk 25A of the secondary encoder 25. In the following description, the magnetic pattern 35B will be assumed to be provided on the rotating disk 25A.

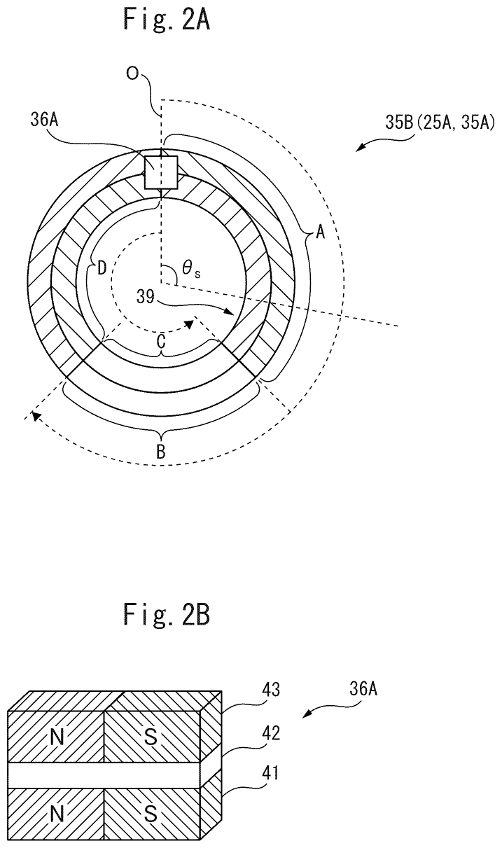

FIG. 2A is a view showing the magnetization pattern of the first embodiment. As shown in FIG. 2A, the magnetic pattern 35B includes a track 39 which extends at least partially in the circumferential direction of the rotating disk 25A.

In FIG. 2A, the track 39 includes a first magnetized sector A which is magnetized so as to switch from one magnetic pole to the other magnetic pole from the inside to the outside in the radial direction of the rotating disk 25A, and a second magnetized sector D which is magnetized so as to switch from the other magnetic pole to the one magnetic pole from the inside to the outside in the radial direction of the rotating disk 25A.

Specifically, the first magnetized sector A and the second magnetized sector D include radially inner portions and radially outer portions of the rotating disk 25A. In one embodiment, the first magnetized sector A includes a radially inner portion which is magnetized to a north pole and a radially outer portion which is magnetized to a south pole. Likewise, the second magnetized sector D includes a radially inner portion which is magnetized to a south pole and a radially outer portion which is magnetized to a north pole. Specifically, the magnetic poles of the radially outer portions and the radially inner portions between the first magnetized sector A and the second magnetized sector D are opposite to each other. Naturally, the polarities of the radially inner portions and the radially inner portions of the first magnetized sector A and the polarities of the radially inner portions and the radially inner portions of the second magnetized sector D may be opposite to those described above.

The first magnetized sector A and the second magnetized sector D are adjacent to each other in the circumferential direction at an origin O of the rotating disk 25A. In other words, the first magnetized sector A extends clockwise on the rotating disk 25A from the origin O, and the second magnetized sector D extends counterclockwise on the rotating disk 25A from the origin O. In the present disclosure, the clockwise direction is defined as the positive direction.

The first magnetized sector A is provided in a region of the track 39 having an angle of equal to or less than (360-θ) degrees about the output shaft 23, and the second magnetized sector D is provided in a region having an angle of equal to or less than −(360-θ) degrees about the output shaft 23.

The remaining portions of the track 39 excluding the first magnetized sector A and the second magnetized sector D are unmagnetized sectors B, C. As can be understood from FIG. 2A, the unmagnetized sector B corresponds to the portion of the radially outer portion of the track 39 described above, and the unmagnetized sector C corresponds to the portion of the radially inner portion of track 39 described above. These unmagnetized sectors B, C are provided in a region of the track 39 which extends over an angle of equal to or greater than ±(θ-180) degrees about the output shaft 23.

In the example shown in FIG. 2A, the first magnetized sector A and the second magnetized sector D extend in opposite directions from the origin O to a position corresponding to an angle of 150°. The unmagnetized sectors B, C extend from a position corresponding to an angle of 150° to a position corresponding to an angle of 210°.

Alternatively, in an unillustrated embodiment, the first magnetized sector A and the second magnetized sector D may extend in opposite directions to a position corresponding to an angle of 10° to 30° from the origin O. The unmagnetized sectors B, C may extend from a position corresponding to an angle of 10° to 30° to a position corresponding to an angle of 320° to 350°. In this case, the detection range, which will be described later, can be increased.

FIG. 2B is a perspective view of a TMR element. The TMR element 36A comprises a reference layer 41, a storage layer 43, and an insulation layer 42 arranged therebetween. In the reference layer 41, a first portion which is magnetized to a north pole and a second portion which is magnetized to a south pole are mutually juxtaposed. The polarities of the first and second portions of the reference layer 41 are determined during production and do not change thereafter. Note that the magnetic polarities of the first and second portions may be reversed.

In the storage layer 43, a first portion which is magnetized to one pole, for example, a north pole, and a second portion which is magnetized to the other pole, for example, a south pole, are mutually juxtaposed. The first and second portions of the storage layer 43 can reverse their polarities depending on the direction of an external magnetic field H acting on the TMR element 36A. The polarity reversal action in the storage layer 43 is based solely on the direction of the external magnetic field H. Thus, no external power is required to reverse the polarity of the storage layer 43, and as a result, no power is required to operate the TMR element 36A. Therefore, the TMR element 36A can be used as a magnetic resistance switch.

Referring again to FIG. 2A, in an initial state, the TMR element 36A is arranged at the origin O and at the center position between the radially outer and inner portions of the rotating disk 25A. Strictly speaking, in the initial state, the center of the insulation layer 42 of the TMR element 36A is arranged between the first magnetized sector A and the second magnetized sector D and between the radially outer and inner portions.

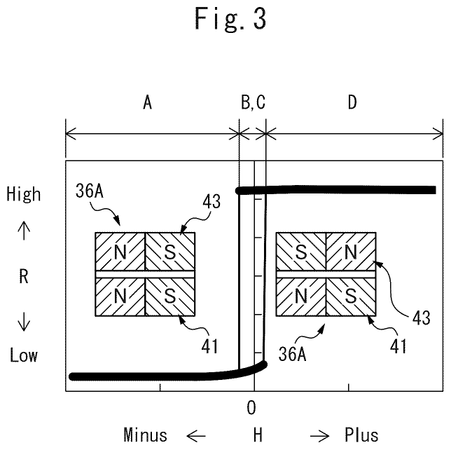

FIG. 3 is a view showing the relationship between magnetic field and resistance, in which the horizontal axis represents the external magnetic field H acting on the TMR element 36A, and the vertical axis represents the resistance R of the TMR element 36A.

As shown on the left in FIG. 3, when the poles of the first and second portions of the reference layer 41 are the same as the poles of the first and second portions of the storage layer 43, the magnetization directions are parallel to each other. In this case, electricity flows easily through the TMR element 36A, and thus, the resistance R of the TMR element 36A is low.

Conversely, as shown on the right in FIG. 3, when the poles of the first and second portions of the reference layer 41 and the poles of the first and second portions of the storage layer 43 are different from each other, the magnetization directions become antiparallel. In this case, it is difficult for electricity to flow through the TMR element 36A, and thus, the resistance R of the TMR element 36A is high. In this manner, the resistance R of the TMR element 36A is generally polarized to a high value (High) or a low value (Low).

Further, as can be understood from FIG. 3, when the external magnetic field H is increased from the negative side, the resistance R rises sharply after the external magnetic field H becomes positive. Likewise, when the external magnetic field H is decreased from the positive side, the resistance R drops sharply after the external magnetic field H becomes negative. In this manner, the TMR element 36A has hysteresis, in which the change in magnetization lags behind the change in the magnetic field.

As can be understood by comparing FIGS. 2A and 3, the resistance R of the TMR element 36A is low when the TMR element 36A faces the first magnetized sector A of the track 39. Conversely, the resistance R of the TMR element 36A is high when the TMR element 36A faces the second magnetized sector D of the track 39.

Furthermore, when the TMR element 36A faces the unmagnetized sectors B, C of the track 39, the resistance R maintains its original value. In other words, when the TMR element 36A moves relatively from the first magnetized sector A toward the unmagnetized sector B, the resistance R remains low. Furthermore, when the TMR element 36A moves relatively from the second magnetized sector D toward the unmagnetized sector C, the resistance R remains high.

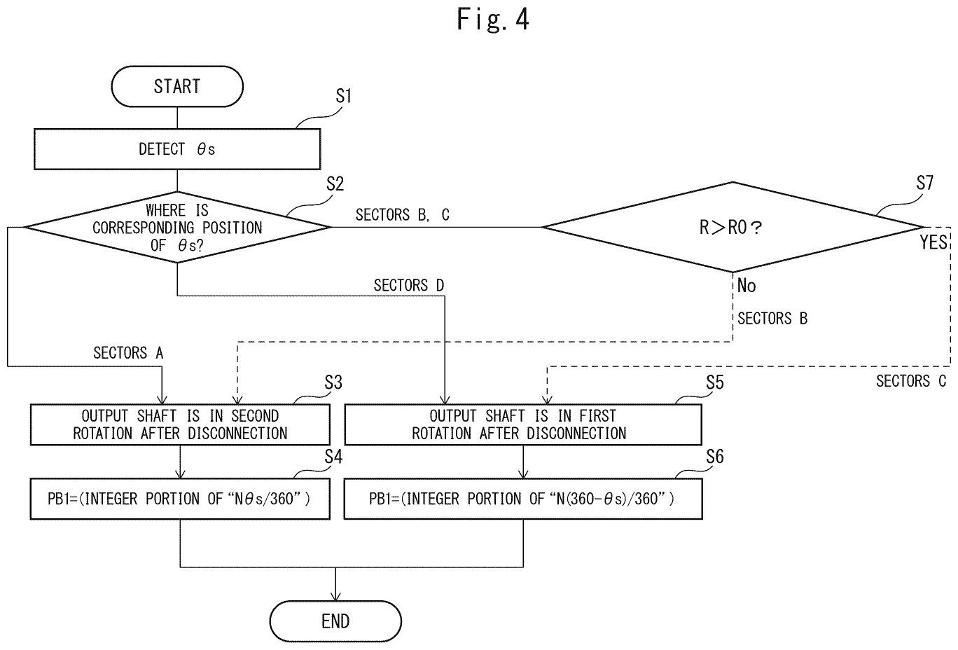

FIG. 4 is a flowchart illustrating the calculation of the total rotation of the motor shaft. The operations shown in FIG. 4 are performed by the controller 9 when the actuator 6 is disconnected from the main power source 19 and the motor shaft 13 of the motor 10 and the output shaft 23 of the speed reducer 20 rotate by inertia and stop. The controller 9 operates the total rotation determination circuit 37 and the calculation part 38 as necessary.

First, in step S1, the detection part 26 detects the angle θs (travel angle) of the output shaft 23 relative to the origin O. In step S2, the total rotation determination circuit 37 then determines in which sector A to D of the track 39 the angle θs is located.

When it is determined in step S2 that the angle θs is in the first magnetized sector A, the process proceeds to step S3. In step S3, the angle θs is positioned in the positive direction area, and in this case, the total rotation determination circuit 37 determines that the output shaft 23 is in the second rotation after being disconnected from the main power source 19.

Next, in step S4, the calculation part 38 calculates the integer portion of “N·θs/360” as the total rotation number PB1 of the motor shaft 13 after disconnection. Furthermore, the calculation part 38 can also calculate the travel angle θp of the motor shaft 13 in the second rotation of the output shaft 23 as “Nθs.”

When it is determined in step S2 that the angle θs is in the second magnetized sector D, the process proceeds to step S5. In step S5, the angle θs is positioned in the negative direction area, and in this case, the total rotation determination circuit 37 determines that the output shaft 23 is in the first rotation after being disconnected from the main power source 19.

Next, in step S6, the calculation part 38 calculates the total rotation number PB1 of the motor shaft 13 after disconnection as the integer portion of “N·(360−θs)/360.” Furthermore, the calculation part 38 can also calculate the travel angle θp of the motor shaft 13 when the output shaft 23 is in the first rotation as “N(360−θs).”

When it is determined in step S2 that the angle θs is in the unmagnetized sectors B, C, the process proceeds to step S7. In step S7, the total rotation determination circuit 37 obtains the resistance R of the TMR element 36A and determines whether the resistance R is greater than a predetermined value R0. The predetermined value R0 is a value between the high value (High) and the low value (Low) shown in FIG. 3.

As can be understood from FIG. 3, if the resistance R is greater than the predetermined value R0, and specifically, if the resistance R is high, it is considered that the angle θs has moved from the second magnetized sector D to the unmagnetized sector C. In this case, the total rotation determination circuit 37 determines that the angle θs is in the unmagnetized sector C, and proceeds to steps S5 and S6. In the same manner as described above, the calculation part 38 then calculates total rotation number PB1, etc., of the motor shaft 13.

Conversely, if the resistance R is equal to or less than the predetermined value R0, and specifically, if the resistance R is low, it is considered that the angle θs has moved from the first magnetized sector A to the unmagnetized sector B. In this case, the total rotation determination circuit 37 determines that the angle θs is in the unmagnetized sector B, and proceeds to steps S3 and S4. In the same manner as described above, the calculation part 38 then calculates total rotation number PB1, etc., of the motor shaft 13.

Thus, in the present disclosure, when the angle θ of the output shaft 23 relative to the origin O is in a position corresponding to the unmagnetized sector B and the resistance R is low, it is determined that the output shaft 23 is in the second rotation after disconnection. Likewise, when the angle θs of the output shaft 23 relative to the origin O is in a position corresponding to the unmagnetized sector C and the resistance R is high, it is determined that the output shaft 23 is in the first rotation after disconnection.

Therefore, in the present disclosure, even after the main power source 19 is disconnected, the total rotation number PB1 of the motor shaft 13 and the total rotation number PB2 of the output shaft 23 can be accurately calculated without power.

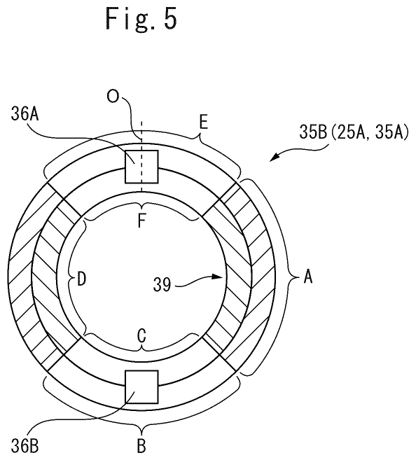

FIG. 5 is a view showing a magnetization pattern of a second embodiment. In FIG. 5, an additional TMR element 36B (an additional magnetic resistance switch) is arranged at a position facing the TMR element 36A in the diametric direction of the annular magnetic pattern 35B. The additional TMR element 36B is arranged facing the rotating disk having the magnetic pattern 35B, for example, the rotating disk 25A.

Further, the track 39 of the magnetic pattern 35B provided in the rotating disk 25A includes additional unmagnetized sectors E, F. As shown in FIG. 5, the additional unmagnetized sectors E, F are positioned diametrically opposite the unmagnetized sectors B, C of the annular magnetic pattern 35B. Specifically, the additional unmagnetized sectors E, F are present near the origin O. The additional unmagnetized sector E is positioned radially outward of the magnetic pattern 35B, and the additional unmagnetized sector F is positioned radially inward of the magnetic pattern 35B.

The circumferential lengths of the additional unmagnetized sectors E, F in the magnetic pattern 35B are preferably the same as, but may be different from, the circumferential lengths of the unmagnetized sectors B, C. When the circumferential lengths of the additional unmagnetized sectors E, F are equal to the circumferential lengths of the unmagnetized sectors B, C, the unmagnetized sectors B, C and the additional unmagnetized sectors E, F are arranged in positions symmetrical to each other relative to the center of magnetic pattern 35B.

As shown in FIG. 5, in the initial state, the center of the insulation layer 42 of the TMR element 36A is centrally positioned on the boundary line between the unmagnetized sectors E, F, and the center of the insulation layer 42 of the additional TMR element 36B is centrally positioned on the boundary line between the unmagnetized sectors B, C.

In such a configuration, as described above, when the actuator 6 is disconnected from the main power source 19 and the motor shaft 13 of the motor 10 and the output shaft 23 of the speed reducer 20 rotate by inertia and stop, the resistance R of the TMR element 36A and the resistance R′ of the additional TMR element 36B are always different from each other.

In other words, if the resistance R and the resistance R′ have the same value, it can be understood that some type of error has occurred. Such an error may be, for example, a failure of at least one of the TMR element 36A and the additional TMR element 36B, and/or the occurrence of a strong external magnetic field influencing the TMR elements 36A, 36B. Thus, in the second embodiment, it is possible to detect, via the controller 9, that the TMR elements 36A, 36B have failed, that a strong external magnetic field has occurred, etc.

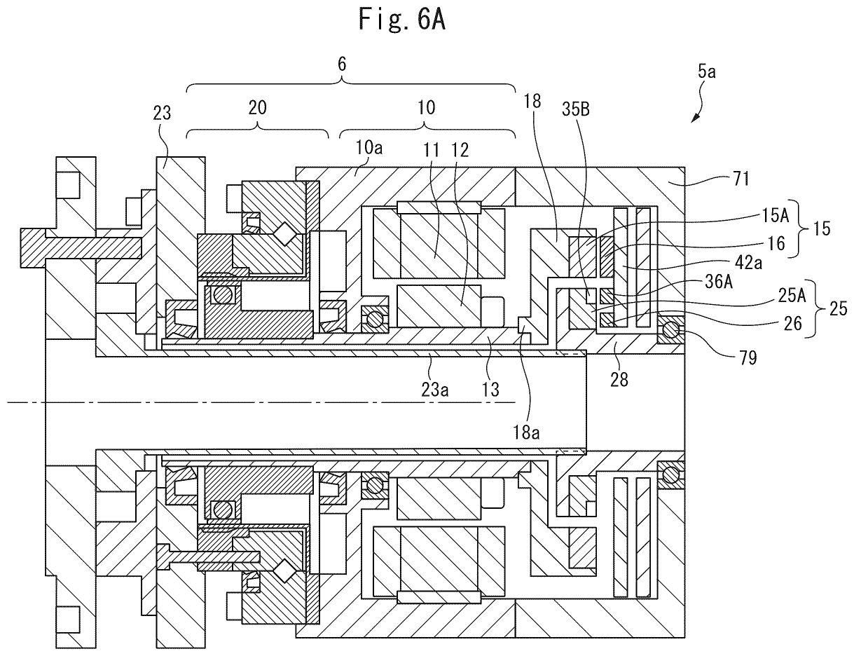

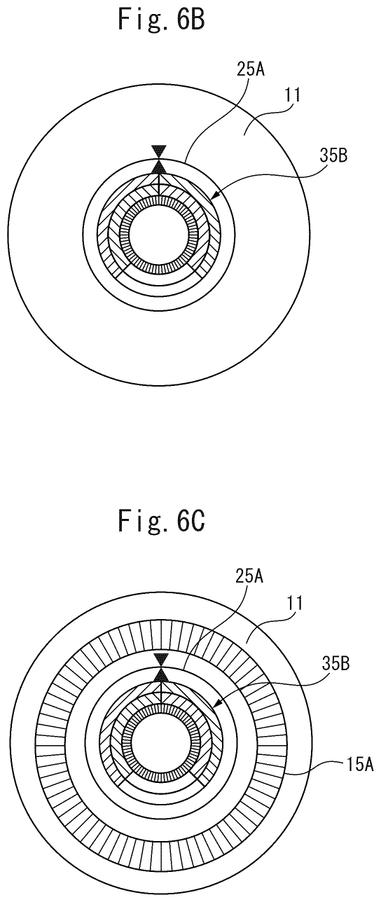

FIG. 6A is a schematic side view of a position detection system based on a third embodiment. Regarding the position detection system 5a shown in FIG. 6A, differences from the previously described embodiments will be primarily described. An extension part 23a, for example, a hollow tube, is joined to the output shaft 23 of the speed reducer 20, and this extension part 23a extends toward the motor 10 through the hollow motor shaft 13. The output shaft 23 of the speed reducer 20 and the extension part 23a may be integrally formed. In other words, the extension part 23a may be a part of the output shaft 23. Therefore, hereinafter, the “extension part 23a” may be expressed as the “output part 23.”

A circular first support member 18 extending in the radial direction is attached to the rear end of the motor shaft 13. An annular protrusion 18a is provided on the first support member 18, and it is preferable that the protrusion 18a engage with the rear end of the motor shaft 13. A radially outer portion of the first support member 18 extends in the axial direction of the motor shaft 13 so as to be spaced from the motor 10. A rotating disk 15A for the primary encoder 15 is provided on the rear end surface of the portion extending in the axial direction. In other words, the rotating disk 15A is supported by a portion of the first support member 18.

A cylindrical extension member 71 is attached to the rear end of a housing 10a of the actuator 6. The rear end surface of the extension member 71 extends radially inward. Furthermore, a second support member 28 is attached via a bearing 79 to the inner circumferential surface of the portion extending radially inward. The inner diameter of the second support member 28 is approximately equal to the inner diameter of the extension part 23a. A substrate 42a on which there are mounted the detection part 16, the detection part 26, and the TMR element 36A is attached to the inner circumferential surface of the extension member 71.

The second support member 28 extends from the rear end of the actuator 6 toward the speed reducer 20, and the tip of the portion extending toward the speed reducer 20 extends radially outward. The rotating disk 25A for the secondary encoder 25 is provided on the rear end surface of the portion extending radially outward. In other words, the rotating disk 25A is supported by a portion of the second support member 28.

The method for assembling the position detection system 5a will be described below. First, in a state in which the rotating disk 15A for the primary encoder 15 is not attached, the motor 10 is DC excited to stop the rotor 12 and motor shaft 13 at their origin positions. The motor shaft 13 is then left in the stopped state.

FIG. 6B is an end view showing the rotating disk and stator of a secondary encoder. Next, as shown in FIG. 6B, the rotating disk 25A for the secondary encoder 25 supported by the second support member 28 is aligned with the origin position. Specifically, a marker provided on the stator 11 in advance is aligned with a marker provided on the rotating disk 25A in advance. As shown in the drawing, these markers are preferably, for example, triangular.

Thereafter, the rotating disk 15A for the primary encoder 15 is attached to the rear end of the motor shaft 13 via the first support member 18. The attachment position (phase) of the rotating disk 15A may be any position. As shown in FIG. 6A, the extension member 71 provided with the substrate 42a is then attached to the housing 10a.

Next, the positions of the rotating disks 15A, 25A within one rotation are detected by the detection parts 16, 26, respectively, and the absolute positions of rotating disks 15A, 25A are stored in the memory as offset amounts. In this manner, after the rotating disks 15A, 25A are installed and when the phase of the motor shaft 13 is stopped at the origin position, the absolute positions of the rotating disk 15A within one rotation and the rotating disk 25A within one rotation are recorded in memory as error amounts. As a result, the position detection system 5a can be available for use early.

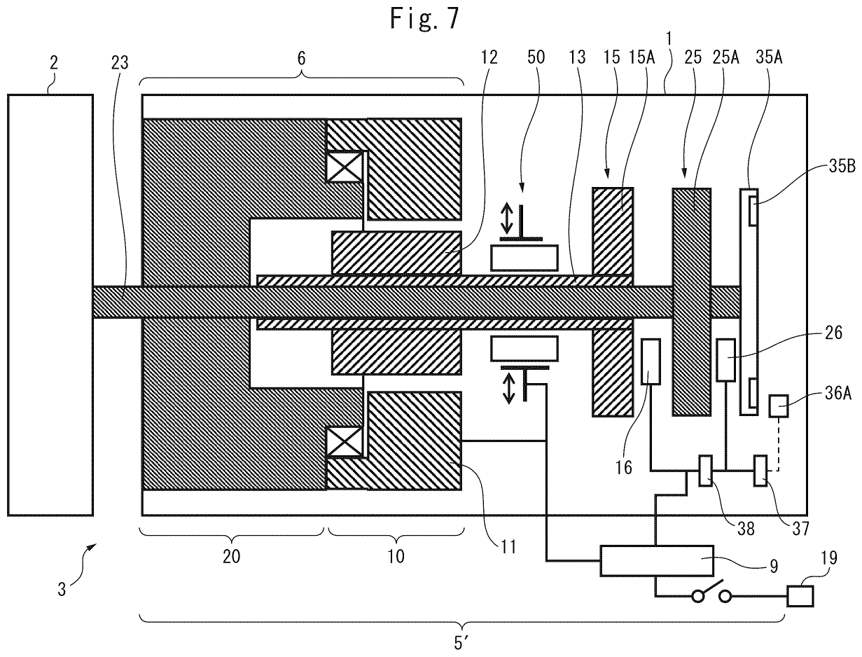

FIG. 7 is a schematic side view of a position detection system based on a fourth embodiment of the present disclosure. In the position detection system 5′ shown in FIG. 7, a new rotating disk 35A is provided coaxially with the rotating disk 25A. The rotating disk 35A is preferably provided so that the rotating disk 25A is positioned between the rotating disk 35A and the rotating disk 15A. In FIG. 7, the rotating disk 35A is provided at the front end of the output shaft 23 passing through the rotating disk 25A. Thus, the rotating disk 35A rotates together with the rotating disk 25A.

In FIG. 7, a magnetic pattern 35B similar to that described above is provided on the rotating disk 35A, but a magnetic pattern 35B is not provided on the rotating disk 25A. Thus, the TMR element 36A is positioned so as to face the magnetic pattern 35B of the rotating disk 35A.

In such a configuration, the same effects as those described above can be achieved. Furthermore, the fourth embodiment has the additional effect in that the rotating disk 35A and the TMR element 36A can be retrofitted to an existing position detection system. Note that the position detection system 5 of the first embodiment has the advantage of being smaller and lighter than the position detection system 5′, which requires the rotating disk 35A, etc.

As an effect of at least one of the embodiments described above, the total rotation number PB1 of the motor shaft 13 can be accurately calculated without power even after the main power source 19 is cut off.

Though the embodiments of the present disclosure have been described in detail, the present disclosure is not limited to the individual embodiments described above. Various additions, replacements, modifications, or partial deletions can be made to these embodiments within the scope of the spirit of the invention, or within the scope of the idea and intent of the present invention derived from the contents described in the claims and their equivalents. For example, the order of each operation and the order of each process of the embodiments described above are shown as examples, and are not limited to these. The same applies when numerical values or formulas are used in the description of the embodiments described above. Furthermore, appropriate combinations of some of the embodiments described above are included in the scope of the present disclosure.

In relation to the embodiments and modification examples described above, the following addenda are further disclosed.

### (Addendum 1)

A position detection system, comprising:
a primary encoder for detecting an absolute angle of a motor shaft of a motor within one rotation, and
a secondary encoder for detecting an absolute angle of an output shaft of a speed reducer joined to the motor within one rotation, wherein
the secondary encoder includes:
a total rotation determination circuit for calculating a total rotation number of the output shaft, and
the total rotation determination circuit includes:
a rotating disk which is magnetized with a specific magnetic pattern and rotates coaxially with the output shaft, and
a magnetic resistance switch which faces the rotating disk, applies a magnetic flux equal to or greater than a predetermined value, and switches resistance value with hysteresis characteristics depending on the direction of the magnetic flux.

### (Addendum 2)

The position detection system according to Addendum 1, wherein the magnetic resistance switch is a TMR element.

### (Addendum 3)

The position detection system according to Addendum 1 or 2, wherein the rotating disk is a rotating disk of the secondary encoder.

### (Addendum 4)

The position detection system according to any one of Addenda 1 to 3, wherein a track which is magnetized with the specific magnetic pattern and which extends at least partially in a circumferential direction of the rotating disk is provided on a surface of the rotating disk, and
the track includes a first magnetized sector which is magnetized so as to switch from one magnetic pole to the other magnetic pole from inside to outside in a radial direction of the rotating disk, a second magnetized sector which is magnetized so as to switch from the other magnetic pole to the one magnetic pole from the inside to the outside in the radial direction of the rotating disk, and an unmagnetized sector which is not magnetized.

### (Addendum 5)

The position detection system according to Addendum 4, wherein when a travel angle of the output shaft is defined as ±θs degrees relative to an origin of the track:
the first magnetized sector is provided in a region of the track of an angle of equal to or less than (360−θs) degrees about the output shaft,
the second magnetized sector is provided in a region of the track of an angle of equal to or less than −(360−θs) degrees about the output shaft, and
the unmagnetized sector is provided in a region of the track of an angle of equal to or greater than ±(θs−180) degrees or more about the output shaft.

### (Addendum 6)

The position detection system according to any one of Addenda 1 to 5, further comprising:
a calculation part, wherein
when a position of the output shaft is defined as θs and a reduction ratio of the speed reducer is defined as 1/N, the calculation part calculates a travel angle θp of the motor shaft in a first rotation of the output shaft as “N(360−θs),” and calculates the travel angle θp of the motor shaft in a second rotation of the output shaft as “Nθs”, and
the calculation part calculates an integer portion of “N(360−θs)/360” in a first rotation of the output shaft as a total rotation number of the motor shaft, and calculates an integer portion of “Nθs/360” in a second rotation of the output shaft as a total rotation number of the motor shaft.

### (Addendum 7)

The position detection system according to Addendum 4, comprising an additional magnetic resistance switch which is arranged on a diametrically opposite side of the rotating disk relative to the magnetic resistance switch and facing the rotating disk, wherein
the track comprises an additional unmagnetized sector which is provided on a diametrically opposite side of the rotating disk relative to the unmagnetized sector.

### (Addendum 8)

An actuator, comprising:
a motor,
a speed reducer joined to the motor,
a primary encoder for detecting an absolute angle of a motor shaft of the motor within one rotation, and
a secondary encoder for detecting an absolute angle of an output shaft of the speed reducer within one rotation, wherein
the secondary encoder includes a total rotation determination circuit for calculating a total rotation of the output shaft, and
the total rotation determination circuit includes:
a rotating disk which is magnetized with a specific magnetic pattern and rotates coaxially with the output shaft, and
a magnetic resistance switch which faces the rotating disk, applies a magnetic flux equal to or greater than a predetermined value, and switches resistance value with hysteresis characteristics depending on the direction of the magnetic flux.

### (Addendum 9)

The actuator according to Addendum 8, wherein the magnetic resistance switch is a TMR element.

### (Addendum 10)

The actuator according to Addendum 8 or 9, wherein the rotating disk is a rotating disk of the secondary encoder.

### (Addendum 11)

The actuator according to any one of Addenda 8 to 9, wherein a track which is magnetized with the specific magnetic pattern and which extends at least partially in a circumferential direction of the rotating disk is provided on a surface of the rotating disk, and
the track includes a first magnetized sector which is magnetized so as to switch from one magnetic pole to the other magnetic pole from inside to outside in a radial direction of the rotating disk, a second magnetized sector which is magnetized so as to switch from the other magnetic pole to the one magnetic pole from the inside to the outside in the radial direction of the rotating disk, and an unmagnetized sector which is not magnetized.

### (Addendum 12)

The actuator according to Addendum 11, wherein when a travel angle of the output shaft is defined as +θs degrees relative to an origin of the track:
the first magnetized sector is provided in a region of the track of an angle of equal to or less than (360−θs) degrees about the output shaft,
the second magnetized sector is provided in a region of the track of an angle of equal to or less than −(360−θs) degrees about the output shaft, and
the unmagnetized sector is provided in a region of the track of an angle of equal to or greater than ±(θ−180) degrees about the output shaft.

### (Addendum 13)

The actuator according to any one of Addenda 8 to 11, further comprising:
a calculation part, wherein
when a position of the output shaft is defined as θs and a reduction ratio of the speed reducer is defined as 1/N, the calculation part calculates a travel angle θp of the motor shaft in a first rotation of the output shaft as “N(360−θs),” and calculates the travel angle θp of the motor shaft in a second rotation of the output shaft as “Nθs”, and
the calculation part calculates an integer portion of “N(360−θs)/360” in a first rotation of the output shaft as a total rotation number of the motor shaft, and calculates an integer portion of “Nθs/360” in a second rotation of the output shaft as a total rotation number of the motor shaft.

### (Addendum 14)

The actuator according to Addendum 11, comprising an additional magnetic resistance switch which is arranged on a diametrically opposite side of the rotating disk relative to the magnetic resistance switch and facing the rotating disk, wherein
the track comprises an additional unmagnetized sector which is provided on a diametrically opposite side of the rotating disk relative to the unmagnetized sector.

DESCRIPTION OF REFERENCE SIGNS

| | |
|---|---|
| 3 | robot |
| 5, 5a, 5' | position detection system |
| 6 | actuator |
| 9 | controller |
| 10 | motor |
| 10a | housing |
| 11 | stator |
| 12 | rotor |
| 13 | motor shaft |
| 15 | primary encoder |
| 15A, 25A, 35A | rotating disk |
| 16 | detection part |
| 19 | main power source |
| 20 | speed reducer |
| 23 | output shaft |
| 25 | secondary encoder |
| 26 | detection part |
| 35B | magnetic pattern |
| 36A, 36B | TMR element |
| | (magnetic resistance switch) |
| 37 | total rotation determination circuit |
| 38 | calculation part |
| 39 | track |
| 41 | reference layer |
| 42 | insulation layer |
| 42a | substrate |
| 43 | storage layer |
| A | first magnetized sector |
| B, C, E, F | unmagnetized sector |
| D | second magnetized sector |

1. A position detection system, comprising:
a primary encoder for detecting an absolute angle of a motor shaft of a motor within one rotation, and
a secondary encoder for detecting an absolute angle of an output shaft of a speed reducer joined to the motor within one rotation, wherein
the secondary encoder includes:
a total rotation determination circuit for calculating a total rotation number of the output shaft, and
the total rotation determination circuit includes:
a rotating disk which is magnetized with a specific magnetic pattern and rotates coaxially with the output shaft, and
a magnetic resistance switch which faces the rotating disk, applies a magnetic flux equal to or greater than a predetermined value, and switches resistance value with hysteresis characteristics depending on the direction of the magnetic flux.

2. The position detection system according to claim 1, wherein the magnetic resistance switch is a TMR element.

3. The position detection system according to claim 1, wherein the rotating disk is a rotating disk of the secondary encoder.

4. The position detection system according to claim 1, wherein a track which is magnetized with the specific magnetic pattern and which extends at least partially in a circumferential direction of the rotating disk is provided on a surface of the rotating disk, and
the track includes a first magnetized sector which is magnetized so as to switch from one magnetic pole to the other magnetic pole from inside to outside in a radial direction of the rotating disk, a second magnetized sector which is magnetized so as to switch from the other magnetic pole to the one magnetic pole from the inside to the outside in the radial direction of the rotating disk, and an unmagnetized sector which is not magnetized.

5. The position detection system according to claim 4, wherein when a travel angle of the output shaft is defined as ±θs degrees relative to an origin of the track:
the first magnetized sector is provided in a region of the track of an angle of equal to or less than (360−θs) degrees about the output shaft,
the second magnetized sector is provided in a region of the track of an angle of equal to or less than −(360−θs) degrees about the output shaft, and
the unmagnetized sector is provided in a region of the track of an angle of equal to or greater than ±(θ−180) degrees about the output shaft.

6. The position detection system according to claim 1, further comprising:
a calculation part, wherein
when a position of the output shaft is defined as θs and a reduction ratio of the speed reducer is defined as 1/N, the calculation part calculates a travel angle θp of the motor shaft in a first rotation of the output shaft as “N(360−θs),” and calculates the travel angle θp of the motor shaft in a second rotation of the output shaft as “Nθs”, and
the calculation part calculates an integer portion of “N(360−θs)/360” in a first rotation of the output shaft as a total rotation number of the motor shaft, and calculates an integer portion of “Nθs/360” in a second rotation of the output shaft as a total rotation number of the motor shaft.

7. The position detection system according to claim 4, comprising an additional magnetic resistance switch which is arranged on a diametrically opposite side of the rotating disk relative to the magnetic resistance switch and facing the rotating disk, wherein
the track comprises an additional unmagnetized sector which is provided on a diametrically opposite side of the rotating disk relative to the unmagnetized sector.

8. An actuator, comprising:
a motor,
a speed reducer joined to the motor,
a primary encoder for detecting an absolute angle of a motor shaft of the motor within one rotation, and
a secondary encoder for detecting an absolute angle of an output shaft of the speed reducer within one rotation, wherein
the secondary encoder includes a total rotation determination circuit for calculating a total rotation of the output shaft, and
the total rotation determination circuit includes:
a rotating disk which is magnetized with a specific magnetic pattern and rotates coaxially with the output shaft, and
a magnetic resistance switch which faces the rotating disk, applies a magnetic flux equal to or greater than a predetermined value, and switches resistance value with hysteresis characteristics depending on the direction of the magnetic flux.

9. The actuator according to claim 8, wherein the magnetic resistance switch is a TMR element.

10. The actuator according to claim 8, wherein the rotating disk is a rotating disk of the secondary encoder.

11. The actuator according to claim 8, wherein a track which is magnetized with the specific magnetic pattern and which extends at least partially in a circumferential direction of the rotating disk is provided on a surface of the rotating disk, and
the track includes a first magnetized sector which is magnetized so as to switch from one magnetic pole to the other magnetic pole from inside to outside in a radial direction of the rotating disk, a second magnetized sector which is magnetized so as to switch from the other magnetic pole to the one magnetic pole from the inside to the outside in the radial direction of the rotating disk, and an unmagnetized sector which is not magnetized.

12. The actuator according to claim 10, wherein when a travel angle of the output shaft is defined as ±θs degrees relative to an origin of the track:
the first magnetized sector is provided in a region of the track of an angle of equal to or less than (360−θs) degrees about the output shaft,
the second magnetized sector is provided in a region of the track of an angle of equal to or less than −(360−θs) degrees about the output shaft, and
the unmagnetized sector is provided in a region of the track of an angle of greater than or equal to ±(θ−180) degrees about the output shaft.

13. The actuator according to claim 10, further comprising:
a calculation part, wherein
when a position of the output shaft is defined as θs and a reduction ratio of the speed reducer is defined as 1/N, the calculation part calculates a travel angle θp of the motor shaft in a first rotation of the output shaft as “N(360−θs),” and calculates the travel angle θp of the motor shaft in a second rotation of the output shaft as “Nθs”, and
the calculation part calculates an integer portion of “N(360−θs)/360” in a first rotation of the output shaft as a total rotation number of the motor shaft, and calculates an integer portion of “Nθs/360” in a second rotation of the output shaft as a total rotation number of the motor shaft.

14. The actuator according to claim 10, comprising an additional magnetic resistance switch which is arranged on a diametrically opposite side of the rotating disk relative to the magnetic resistance switch and facing the rotating disk, wherein
the track comprises an additional unmagnetized sector which is provided on a diametrically opposite side of the rotating disk relative to the unmagnetized sector.
